(19) United States
(12) Patent Application Publication
(10) Pub. No.: US 2024/0427822 A1
(43) Pub. Date: Dec. 26, 2024

(54) Document Clause Comparison Using Transformers and Neural Vector Embeddings

(71) Applicant: Cognizer, Inc., Pleasanton, CA (US)

(72) Inventors: Jack Porter, Valley Springs, CA (US); Rajiv Baronia, San Ramon, CA (US); Avijit Dasgupta, Hyderabad (IN); Vineeth Thanikonda Munirathnam, Bangalore (IN); Suzanne M. Kirch, Waltham, MA (US)

(21) Appl. No.: 18/751,171

(22) Filed: Jun. 21, 2024

Related U.S. Application Data
(60) Provisional application No. 63/522,301, filed on Jun. 21, 2023.

(51) Int. Cl. G06F 16/93; G06F 40/151; G06F 40/284; G06Q 50/18

(52) U.S. Cl. CPC G06F 16/93; G06F 40/151; G06F 40/284; G06Q 50/18

(57) ABSTRACT

System, method, apparatus, and program instruction for comparing an input query clause with a collection of document clauses to determine which document clause is most similar to the query clause is provided. The disclosed invention includes an improved process of storing a collection of natural language data, improving both the generalizability and accuracy of searching and comparison of natural language data.

### CROSS REFERENCE TO RELATED APPLICATIONS

This application claims priority from a provisional U.S. patent application No. 63/522,301 filed on Jun. 21, 2023.

### FIELD OF THE INVENTION

Embodiments of the invention generally relate to natural language processing, more particularly, to the usage of transformers and neural vector embeddings for document clause comparison.

### BACKGROUND

Semantic parsing is the task of transforming natural language text into a machine-readable formal representation. Natural language processing (NLP) involves the use of artificial intelligence to process and analyze large amounts of natural language data. Because NLP models cannot understand text, the natural language data is first converted into numerical representations called embeddings. Word embeddings are vector representations of words that allow words with similar meanings to have similar vector representations. Thus, words with similar meanings are grouped together when converted to vector representations. Using transformers, neural vector embeddings can be generated for both individual words and entire sentences. These embeddings have the capability to separate distinct meanings of a word or the semantic nuances of a sentence by considering the contextual information surrounding them.

Semantic textual similarity is the process of comparing texts to determine how contextually similar they are. Large language models, such as BERT, RoBERTa, and Albert, have been utilized for semantic textual similarity, but due to quadratic complexity of the attention mechanism, these models are typically limited to an overall input sequence length of 512 tokens. This input sequence length can accommodate a typical sentence, but cannot scale to arbitrarily long sequences of text. Moreover, such approaches also have high time complexity, as performing pairwise comparison across billions of documents is prohibitively expensive. Other transformer architectures, such as Longformer, ETC, BigBird, and Reformer, allow for longer input sequence lengths. While these models improve the input sequence length, they still cannot allow for an arbitrary length input text. Moreover, introducing constraints on the attention mechanism results in a slight drop of accuracy. Other transformer models, such as Sentence Transformers, SimCSE, DiffCSE, DCLR, EASE, and DPR, have been created specifically to perform semantic textual similarity. These models utilize a siamese architecture that computes the embedding of two sentences separately and then computes the similarity between them by computing cosine similarity. While this approach is much more scalable as it computes the embeddings of each input sequence independently, these models can only take a maximum of 512 tokens as input to compute embeddings that greatly limits its applicability to text that can be arbitrarily sized. Other approaches, such as CDLM, ASPIRE, MSPP, and SDR, have tried to aggregate the input sentence embeddings to create a unified embedding for a larger sequence by training the transformer models at the document level. While these approaches can be scaled to arbitrarily long documents, up to 64 k in length, at some point, the information that can be preserved in a vector will start deteriorating, as the model begins to forget information that it read at the beginning of the document.

Comparing texts, to determine how contextually similar they are, can be done for a wide variety of documents, such as books or research papers. Comparing contracts is an essential part of any Contract Lifecycle Management System. Contracts are divided into clauses, which are sections of the contract that dictate the conditions under which the contract is legally enforceable.

The same clause type can be written with substantial language variations making direct comparisons between clauses difficult. To compare clauses (or any document section such as chapters in books) successfully, it is necessary to understand the meaning conveyed by text.

### SUMMARY

Comparing texts, to determine how contextually similar they are, can be done for a wide variety of documents, such as books or research papers. Comparing contracts is an essential part of any Contract Lifecycle Management System. Contracts are documents that are divided into sections called clauses, which can be further divided into passages. Contracts are divided into clauses, which are sections of the contract that dictate the conditions under which the contract is legally enforceable. For the purpose of this disclosure, it should be understood that documents comprises clauses, which comprise passages. While the teachings of this invention are applicable to a wide range of documents and texts, this disclosure will describe the process of document comparison through a contract's sections known as clauses, and no limitation is intended. Because the same clause type can be written with substantial language variations, comparing clauses requires understanding the meaning conveyed by text.

System, method, apparatus, and program instruction for comparing an input query clause with a collection of document clauses to determine which document clause is most similar to the query clause is provided. The disclosed invention includes an improved process of storing a collection of natural language data, improving both the generalizability and accuracy of searching and comparison of natural language data. The disclosed invention utilizes a transformer architecture for document ingestion whereby natural language text is converted to embeddings and stored in a database as a collection of document clauses and document clause passages. The same transformer network receives as input a query clause and converts it to embeddings so that it can be compared with the stored document clause embeddings. A query-conditioned transformer network compares the input query clause embedding with a list of potentially similar document clause embeddings from the collection to determine which document clause is most similar to the query clause. An explanation for comparing an input query clause with a collection of document clauses to determine which document clause is most similar to the query clause using a transformer follows.

The disclosed invention comprises receiving, as input, a query document, splitting the query document into query passages, wherein each query passage is a pre-configured number of tokens in length, converting, by a transformer, each query passage in sequence into a query passage embedding, generating an embedding for the entire query document as a query aggregation embedding by performing an aggregating operation on the query passage embeddings, for each query passage embedding, retrieving, from an embedding storage engine containing document passage embeddings of the pre-configured number of tokens in length, document passage embeddings that most closely match the query passage embedding, for each retrieved document passage embedding, retrieving from the embedding storage engine, the corresponding aggregation embedding and all of its document passage embeddings, for all of the passage embeddings, generating, by a query-conditioned transformer network, an embedding for the document passage that is conditioned by the query as a query-conditioned document passage embedding, generating a query-conditioned document embedding by performing the aggregating operation on the query-conditioned document passage embedding, calculating a similarity between each document embedding and the query document embedding and between each query-conditioned document embedding and the query document embedding.

### BRIEF DESCRIPTION OF THE DRAWINGS

The accompanying drawings taken in conjunction with the detailed description will assist in making the advantages and aspects of the disclosure more apparent.

FIG. 1 depicts a document clause ingestion module.

FIG. 2 depicts a system embodiment configured to compare a query clause and a document clause.

FIG. 3 depicts a query clause embedding module.

FIG. 4 depicts a process of creating a query-conditioned document clause embedding.

### DETAILED DESCRIPTION OF THE INVENTION

Reference will now be made in detail to the present embodiments discussed herein, illustrated in the accompanying drawings. The embodiments are described below to explain the disclosed method, system, apparatus, and program by referring to the figures using like numerals.

The subject matter is presented in the general context of program modules and/or in computer hardware, including the structures disclosed in this specification and their structural equivalents, or in combinations of one or more of them. Those skilled in the art will recognize that other implementations may be performed in combination with other types of program and hardware modules that may include different data structures, components, or routines that perform similar tasks. The invention can be practiced using various computer system configurations and across one or more computers, including but not limited to clients and servers in a client-server relationship. Computers encompass all kinds of apparatus, devices, and machines for processing data, including by way of example, one or more programmable processors, memory, and can optionally include, in addition to hardware, computer programs and the ability to receive data from or transfer data to, or both, mass storage devices. A computer program, which may also be referred to or described as a program, software, a software application, an app, a module, a software module, a script, or code, can be written in any form of programming language, including compiled or interpreted languages, or declarative or procedural languages; it can be deployed in any form, including as a stand-alone program or as a module, component, subroutine, or other unit suitable for use in a computing environment deployed or executed on one or more computers.

Unless otherwise defined, all terms (including technical and scientific terms) used herein have the same meaning as commonly understood by one having ordinary skill in the art to which this invention belongs. In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. The specification and claims should be read with the understanding that such combinations are entirely within the scope of the invention and the claims.

It will nevertheless be understood that no limitation of the scope is thereby intended, such alterations and further modifications in the illustrated invention, and such further applications of the principles as illustrated therein being contemplated as would normally occur to one skilled in the art to which the embodiments relate. The present disclosure is to be considered as an exemplification of the invention, and is not intended to limit the invention to the specific embodiments illustrated by the figures or description below.

Comparing texts, to determine how contextually similar they are, can be done for a wide variety of documents, such as books or research papers. Comparing contracts is an essential part of any Contract Lifecycle Management System. Contracts are documents that are divided into sections called clauses, which can be further divided into passages. Contracts are divided into clauses, which are sections of the contract that dictate the conditions under which the contract is legally enforceable. For the purpose of this disclosure, it should be understood that documents comprises clauses, which comprise passages. While the teachings of this invention are applicable to a wide range of documents and texts, this disclosure will describe the process of document comparison through a contract's sections known as clauses, and no limitation is intended. Because the same clause type can be written with substantial language variations, comparing clauses requires understanding the meaning conveyed by text.

System, method, apparatus, and program instruction for comparing an input query clause with a collection of document clauses to determine which document clause is most similar to the query clause is provided. The disclosed invention includes an improved process of storing a collection of natural language data, improving both the generalizability and accuracy of searching and comparison of natural language data. The disclosed invention utilizes a transformer architecture for document ingestion whereby natural language text is converted to embeddings and stored in a database as a collection of document clauses and document clause passages. The same transformer network receives as input a query clause and converts it to embeddings so that it can be compared with the stored document clause embeddings. A query-conditioned transformer network compares the input query clause embedding with a list of potentially similar document clause embeddings from the collection to determine which document clause is most similar to the query clause. An explanation for comparing an input query clause with a collection of document clauses to determine which document clause is most similar to the query clause using a transformer follows.

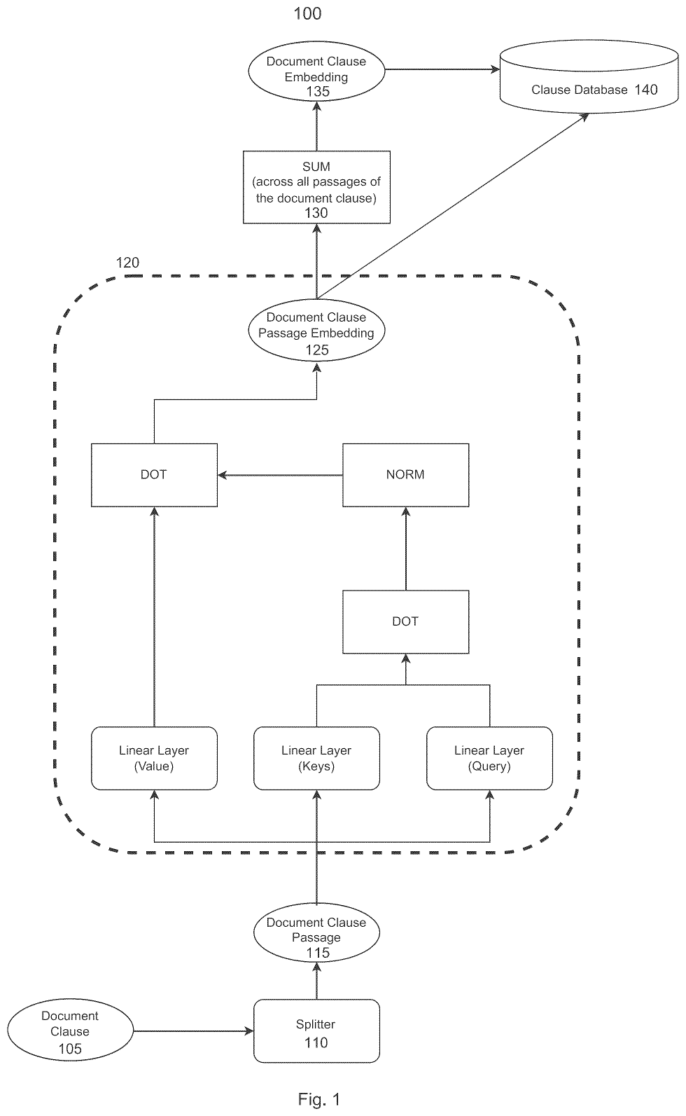

An improved process of ingesting and storing a collection of natural language data is provided. As illustrated in FIG. 1, an ingestion module 100 configured to convert a natural language text document to embeddings and store the embeddings is provided. In the preferred embodiment, the embeddings are neural vector embeddings. The ingestion module comprises a splitter and a passage embedding transformer and can include a storage engine. Such an embodiment can utilize software, firmware, hardware, or a combination of them that perform operations or actions. A document clause 105, stored in memory or accessed from another computer, is received. While the input in the preferred embodiment is a document clause, this disclosure contemplates different natural language text lengths and formats as input. The document clause is fed into a splitter 110 which splits the clause into smaller passages 115, which are 512 tokens in length in the preferred embodiment. The passages are passed to a transformer 120 which takes the inputs in a sequential manner and converts the passage as keys, queries, and values (using a linear layer). Finally, they are combined using dot products and summations to obtain document clause passage embeddings 125, which are then indexed. In the preferred embodiment, the overall network is trained in a self-supervised manner to encourage passages from the same document clause to be closer in the embedding space.

The ingestion module not only converts passages into embeddings for a limited number of tokens, which is 512 in the preferred embodiments, but also computes an embedding for the document clause as an aggregation of the document clause passage embeddings. The document clause embedding 135 is computed using an aggregation operation 130 that includes, but is not limited to, a sum or weighted average of the document clause passage embeddings. An embedding for an entire document can be computed by the same aggregation of the document's clause embeddings or by the same aggregation of the document clause passage embeddings for all of the document. Generally, the latter, which involves aggregating a larger number of embeddings, increases accuracy but reduces speed and efficiency, when the aggregation operation is a weighted average.

Training of the passage embedding transformer is done by passing a known input, generating an output using the transformer as it currently is, then comparing it to the known correct output, and modifying the transformer accordingly to improve the accuracy of the results. Over time, the transformer is trained to generate the known output for all natural language data input. In the preferred embodiment the transformer has been trained on legal data and fine-tuned to extract the similarity of passages. The transformer network is trained in such a way to encourage similar passages to exist close to each other in the embedding space.

In the preferred embodiments, the document clause embeddings and the document clause passage embeddings are stored in a document-embedding storage engine, referred to as a Clause Database 140 in this disclosure. This disclosure contemplates the use of registries, datastores or other storage alternatives, structured or unstructured, to a database. Such a database can be located on the same physical device, integrated programmatically, or connected via a network as the transformer network. Metadata or other means known to those skilled in the art identify whether an embedding is a clause embedding or a passage embedding. While the present disclosure describes a Clause Database, any type of document can be stored in such a database by dividing the document into passages, which are 512 token in length in the preferred embodiment. Comingling of different document types can occur as documents can be indexed according to document type to identify the document type in the database. While such different documents can have natural sections, such as chapters in a book, or can be arbitrary, the database stores embeddings of the same dimension for all documents, sections, and subsections. The resulting collection of document embeddings can be utilized for a variety of tasks, which includes finding similar documents and answering a query. As disclosed, the ingestion module is capable of ingesting and storing documents of any type, length, and having any number of sections and further subsections to create a collection of document embeddings, and no limitation is intended.

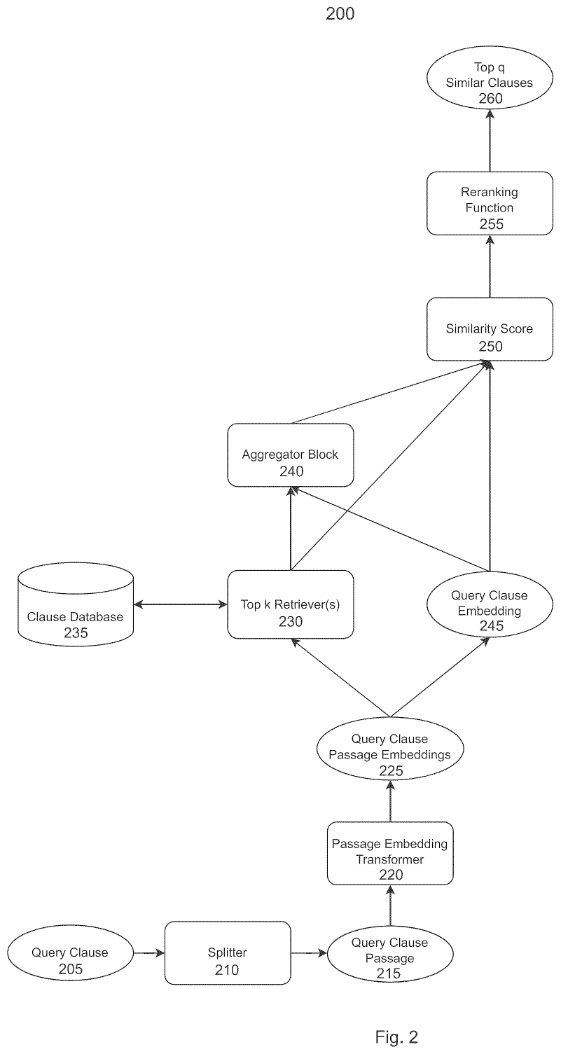

As illustrated in FIG. 2, a system embodiment 200 for comparing an input query clause with a collection of document clauses to determine which document clause is most similar to the query clause is provided. Such an embodiment can utilize software, firmware, hardware, or a combination of them that are configured to perform operations or actions. The processes and steps described below can be performed by one or more computers or computer components or one or more computer or computer components executing one or more computer programs to perform functions by operating on input and generating output.

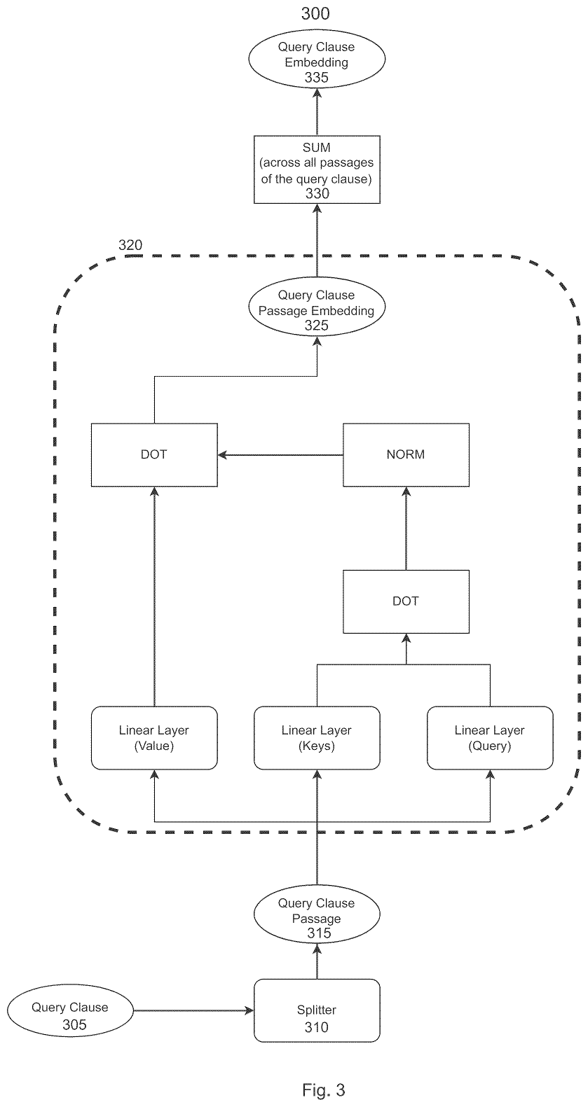

A natural language text query clause, stored in memory or accessed from another computer is received. In order to compare the query clause with other document clauses in the Clause Database, the query clause must be converted to embeddings. This is done by a module identical to the ingestion module shown in FIG. 1, whereby the query clause 205 is divided by a splitter 210 into query clause passages 215, which are converted by a passage embedding transformer 220 into query clause passage embeddings 225. This is further illustrated in FIG. 3.

As illustrated in FIG. 3, a module 300 identical to the one shown in FIG. 1, is configured to convert a query clause to embeddings is provided. This module is trained to be identical to the ingestion module because the query clause will be embedded in the exact same way as the document clauses in the Clause Database so that they can be compared for contextual similarity. The query clause 305 is fed into a splitter 310 which splits the clause into smaller passages, which are 512 tokens in length in the preferred embodiment. The query clause passages 315 are passed to a transformer 320 which takes the inputs in a sequential manner and converts the passage as keys, queries, and values (using a linear layer). Finally, they are combined using dot products and summations to obtain query clause passage embeddings 325, which are then indexed. A query clause embedding 335 is computed using the same aggregation operation 330 as described above during ingestion on the query clause passage embeddings.

Continuing in FIG. 2, after the query clause is converted to embeddings, each query passage embedding is passed to one or more retrievers 230, which in the preferred embodiment is 2 retrievers. Each retriever is configured to retrieve from the Clause Database 235 the top k closest matching document clause passage embeddings to the query clause passage embedding. In the preferred embodiment, one retriever is a sparse retriever, which uses BM25. The other retriever is a dense retriever that is trained in an unsupervised manner to retrieve relevant document clause passages using cosine similarity between the dense embedding of the query clause passage and the dense embedding of the document clause passage. The dense embedding is trained using a triplet loss that encourages similar embeddings to be close to each other and dissimilar embeddings to be far away. Since the number of pairwise comparisons is high, in order to ensure a fast inference, an approximate nearest neighbor (ANN) algorithm, like HNSW, is utilized in the dense retriever. Other retrievers may be used, and no limitation is intended. The Top k Retrievers 230 retrieve the embeddings for the top k closest document clause passages for each query clause passage. The document clause can be identified from each retrieved document clause passage. Thus, the document clause embedding and all of its document clause passage embeddings are retrieved for each retrieved top k document clause passage embedding.

A document clause embedding retrieval example by the top k retrievers is further provided. Using a query clause (QC) that comprises three passages (QCP1, QCP2, QCP3), the two query clause passages are passed to the two top k retrievers, where k is 2 in this example. The Clause Database contains document clause embeddings (DC #) and document clause passage embeddings (DC #P #). Because, the retrievers employ different algorithms, the set of document clause passages retrieved will differ between retrievers. However, because both retrievers are ultimately retrieving document clause passages similar to the query clause passage, overlap will occur.

The first retriever retrieves two document clause passage embeddings for each query clause passage:
For QCP1: DC1P1, DC2P1
For QCP2: DC2P2, DC4P2
For QCP3: DC3P2, DC4P3
   For each document clause passage, the retriever will retrieve the document clause embedding and all of its document clause passage embeddings. Thus, the retreiver will retrieve the distinct document clauses, which are DC1, DC2, DC3, DC4, and all of the document clause passage embeddings for those document clauses.

The second retriever two document clause passage embeddings for each query clause passage:
For QCP1: DC1P1, DC5P1
For QCP2: DC6P2, DC7P2
For QCP3: DC3P2, DC7P3
   For each document clause passage, the retriever will retrieve the document clause embedding and all of its document clause passage embeddings. Thus, the retreiver will retrieve the distinct document clauses, which are DC1, DC3, DC5, DC6, DC7 and all of the document clause passage embeddings for those document clause.

The document clause lists identified by the top k retrievers are combined to create a top document clause list. The document clause passage embeddings for all of the retrieved document clauses on the top document clause list are passed to an Aggregator Block 240, which is a query-conditioned transformer network, along with the query clause embedding 245.

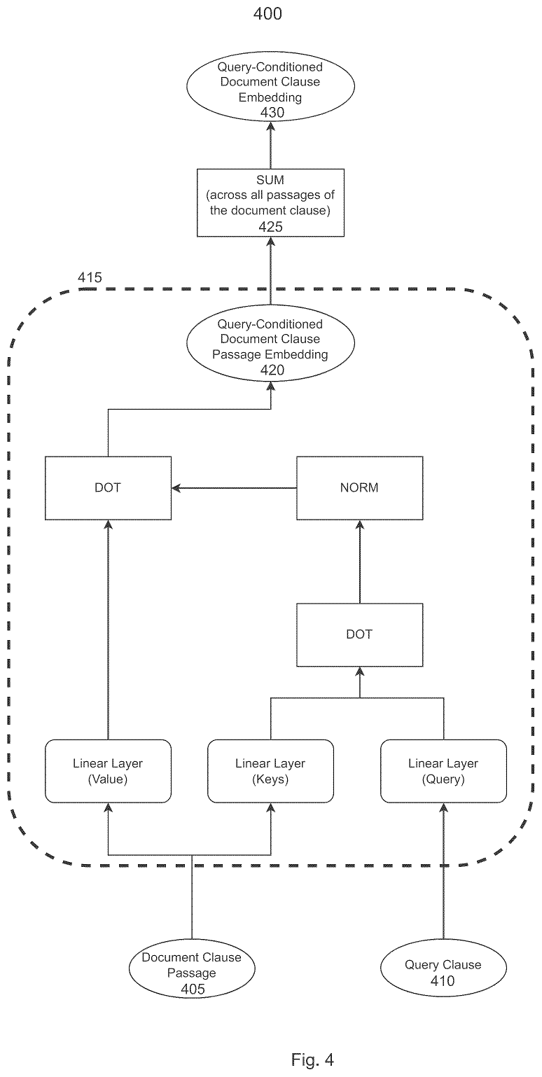

As illustrated in FIG. 4, the Aggregator Block 400 receives as input each document clause passage embedding 405 in sequence and the query clause embedding 410. For each document clause passage embedding, the disclosed transformer 415 generates the query-conditioned document clause passage embedding 420, i.e. an embedding for the document clause passage that is conditioned by the query clause. A query-conditioned document clause embedding 430 is computed using the same aggregation operation 425 as describe above during ingestion on the query-conditioned document clause passage embeddings. A query-conditioned document clause embedding is calculated for each document clause in the top document clauses list. The output of the Aggregator Block is the full set of query-conditioned document clause embeddings.

The Similarity Score 250 block receives the full set of query-conditioned document clause passage embeddings, the full set of retrieved document clause embeddings, and the query clause embedding as input. This block calculates the similarity score, which in the preferred embodiment is a Cosine Similarity, though no limitation is intended, between each document clause embedding and the query clause and between each query-conditioned document clause embedding and the query clause embedding. In alternative embodiments, the block may calculate the similarity score between each document clause embedding and the query clause or between each query-conditioned document clause embedding and the query clause, rather than both as done in the preferred embodiment. The Similarity Score block outputs the top k′ similar document clauses, where k′ can be a determined number or the number of document clauses that exceed a determined similarity score threshold.

The top k′ document clauses are passed through a re-ranker function 255. In the preferred embodiment, normalized discounted cumulative gain (NDCG) function for the re-ranking task is utilized. Alternative re-ranking means can be utilized, and no limitation is intended. The resulting output is the top q document clauses 260 from the Clause Database corresponding to the query clause.

The preceding description contains embodiments of the invention, and no limitation of the scope is thereby intended. It will be further apparent to those skilled in the art that various modifications and variations can be made in the present invention without departing from the spirit or scope of the invention.

1. A computer-implemented method for document ingestion comprising:
receiving, as input, a document;
splitting the document into passages, wherein each passage is a pre-configured number of tokens in length;
converting, by a transformer, each passage in sequence to a passage embedding;
generating an embedding for the entire document as an aggregation embedding, by performing an aggregating operation on the passage embeddings.

2. The method of claim 1 further comprising:
storing the passage embeddings and aggregation embedding in an embedding storage engine.

3. The method of claim 1, wherein the aggregation operation is a weighted average operation.

4. The method of claim 1, wherein the aggregation operation is a sum operation.

5. The method of claim 2, wherein metadata identifying whether an embedding is a passage embedding or an aggregation embedding is stored with each embedding.

6. The method of claim 2, wherein metadata identifying what type of a document an embedding is for, is stored with each embedding.

7. The method of claim 1, wherein splitting the document into passages is done by splitting the document into its document specific sections and then splitting each section into passages; and generating an embedding for the entire document is done by performing an aggregating operation on the passage embeddings to create section embeddings and then performing an aggregating operation on the section embeddings to create the aggregation embedding.

8. The method of claim 1, wherein the document is a contract.

9. The method of claim 8, wherein splitting the contract into passages is done by splitting the document into contract clauses and then splitting each contract clause into passages;
and generating an embedding for the entire contract is done by performing an aggregating operation on the passage embeddings to create contract clause embeddings and then performing an aggregating operation on the contract clause embeddings to create the aggregation embedding.

10. A computer-implemented method for document comparison comprising:
receiving, as input, a query document;
splitting the query document into query passages, wherein each query passage is a pre-configured number of tokens in length;
converting, by a transformer, each query passage in sequence into a query passage embedding;
generating an embedding for the entire query document as a query aggregation embedding by performing an aggregating operation on the query passage embeddings;
for each query passage embedding, retrieving, from an embedding storage engine containing document passage embeddings of the pre-configured number of tokens in length, document passage embeddings that most closely match the query passage embedding;
for each retrieved document passage embedding, retrieving from the embedding storage engine, the corresponding aggregation embedding and all of its document passage embeddings;
for all of the passage embeddings, generating, by a query-conditioned transformer network, an embedding for the document passage that is conditioned by the query as a query-conditioned document passage embedding;
generating a query-conditioned document embedding by performing the aggregating operation on the query-conditioned document passage embedding;
calculating a similarity between each document embedding and the query document embedding and between each query-conditioned document embedding and the query document embedding.

11. The method of claim 10 further comprising:
reranking the documents according to their calculated similarity with the query.

12. The method of claim 10, wherein the aggregation operation is a weighted average operation.

13. The method of claim 10, wherein the aggregation operation is a sum operation.

14. The method of claim 10, wherein the similarity is a cosine similarity.

15. The method of claim 10, wherein the number of document passage embeddings that most closely match the query passage embedding retrieved is a specified number k.

16. The method of claim 10, wherein the document passage embeddings that most closely match the query passage embedding are retrieved by a dense retriever and a sparse retriever.

17. The method of claim 10, wherein the query document is a contract.

18. A computer-implemented method for contract clause comparison comprising:
receiving, as input, a query contract clause;
splitting the query contract clause into query passages, wherein each query passage is a pre-configured number of tokens in length;
converting, by a transformer, each query passage in sequence into a query passage embedding;
generating an embedding for the entire query contract clause as a query aggregation embedding by performing an aggregating operation on the query passage embeddings;
for each query passage embedding, retrieving, from an embedding storage engine containing contract clause passage embeddings of the pre-configured number of tokens in length, contract clause passage embeddings that most closely match the query passage embedding;
for each retrieved contract clause passage embedding, retrieving from the embedding storage engine, the corresponding aggregation embedding and all of its contract clause passage embeddings;
for all of the passage embeddings, generating, by a query-conditioned transformer network, an embedding for the contract clause passage that is conditioned by the query as a query-conditioned contract clause passage embedding;
generating a query-conditioned contract clause embedding by performing the aggregating operation on the query-conditioned contract clause passage embedding;
calculating a similarity between each document embedding and the query document embedding and between each query-conditioned document embedding and the query document embedding.
